(19) United States
(12) Patent Application Publication
(10) Pub. No.: US 2015/0033559 A1
(43) Pub. Date: Feb. 5, 2015

(54) REPAIR OF A SUBSTRATE WITH COMPONENT SUPPORTED FILLER

(71) Applicants: Gerald J. Bruck, Oviedo, FL (US); Ahmed Kamel, Orlando, FL (US)

(72) Inventors: Gerald J. Bruck, Oviedo, FL (US); Ahmed Kamel, Orlando, FL (US)

(21) Appl. No.: 13/956,635

(22) Filed: Aug. 1, 2013

(51) Int. Cl. B23P 6/04; B23P 6/00

(52) U.S. Cl. CPC B23P 6/045; B23P 6/007; B23P 6/04
USPC 29/889.1; 29/402.07

(57) ABSTRACT

In a method of repairing a component substrate (18), especially a substrate (18) composed of a superalloy such as a nickel based superalloy, a portion of the substrate (18) at a distressed region (26) to be repaired is removed forming a repair opening (28) through the substrate (18). The repair opening (28) is adjacent to an internal cavity (20) of the component (10). The cavity (20) is filled with a filler material (30) such as a powdered metal alloy having a composition corresponding to that of the substrate (18). Heat is then applied to the filler material (30) and across the repair opening (28) to melt the filler material, which is allowed to cool to form a repair deposit (36, 40, 50) fused to the substrate (18) and across the opening (28). Any un-consumed filler material (30) is subsequently removed from the cavity (20).

### FIELD OF THE INVENTION

This invention relates generally to the field of metals joining and, more particularly, to a process for depositing metal using a laser heat source.

### BACKGROUND OF THE INVENTION

Welding processes vary considerably depending upon the type of material being welded. Some materials are more easily welded under a variety of conditions, while other materials require special processes in order to achieve a structurally sound joint without degrading the surrounding substrate material.

Common arc welding generally utilizes a consumable electrode as the feed material. In order to provide protection from the atmosphere for the molten material in the weld pool, an inert cover gas or a flux material may be used when welding many alloys including, e.g. steels, stainless steels, and nickel based alloys. Inert and combined inert and active gas processes include gas tungsten arc welding (GTAW) ((also known as tungsten inert gas (TIG)) and gas metal arc welding (GMAW) ((also known as metal inert gas (MIG) and metal active gas (MAG)). Flux protected processes include submerged arc welding (SAW) where flux is commonly fed, flux cored arc welding (FCAW) where the flux is included in the core of the electrode and shielded metal arc welding (SMAW) where the flux is coated on the outside of the filler electrode.

The use of energy beams as a heat source for welding is also known. For example, laser energy has been used to melt pre-placed stainless steel powder onto a carbon steel substrate with powdered flux material providing shielding of the melt pool. The flux powder may be mixed with the stainless steel powder or applied as a separate covering layer. To the knowledge of the inventors, flux materials have not been used when welding superalloy materials.

It is recognized that superalloy materials are among the most difficult materials to weld due to their susceptibility to weld solidification cracking and strain age cracking. The term “superalloy” is used herein as it is commonly used in the art; i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g., IN 738, IN 792, IN 939), Rene alloys (e.g., Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys.

Weld repair of some superalloy materials has been accomplished successfully by preheating the material to a very high temperature (for example to above 1600° F. or 870° C.) in order to significantly increase the ductility of the material during the repair. This technique is referred to as hot box welding or superalloy welding at elevated temperature (SWET) weld repair, and it is commonly accomplished using a manual GTAW process. However, hot box welding is limited by the difficulty of maintaining a uniform component process surface temperature and the difficulty of maintaining complete inert gas shielding, as well as by physical difficulties imposed on the operator working in the proximity of a component at such extreme temperatures.

Some superalloy material welding applications can be performed using a chill plate to limit the heating of the substrate material; thereby limiting the occurrence of substrate heat affects and stresses causing cracking problems. However, this technique is not practical for many repair applications where the geometry of the parts does not facilitate the use of a chill plate.

FIG. 11 is a conventional chart illustrating the relative weldability of various alloys as a function of their aluminum and titanium content. Alloys such as Inconel® 718 which have relatively lower concentrations of these elements, and consequentially relatively lower gamma prime content, are considered relatively weldable, although such welding is generally limited to low stress regions of a component. Alloys such as Inconel® 939 which have relatively higher concentrations of these elements are generally not considered to be weldable, or can be welded only with the special procedures discussed above which increase the temperature/ductility of the material and which minimize the heat input of the process. For purposes of discussion herein, a dashed line 80 indicates a border between a zone of weldability below the line 80 and a zone of non-weldability above the line 80. The line 80 intersects 3 wt. % aluminum on the vertical axis and 6 wt. % titanium on the horizontal axis. Within the zone of non-weldability, the alloys with the highest aluminum content are generally found to be the most difficult to weld.

It is also known to utilize selective laser melting (SLM) or selective laser sintering (SLS) to melt a thin layer of alloy powder particles onto an alloy substrate. The melt pool is shielded from the atmosphere by applying an inert gas, such as argon, during the laser heating. These processes are often performed in a “full bath” chamber, in which a component to be repaired is submerged in a powdered metal filling the chamber. Accordingly, a large amount of unconsumed powdered metal alloy is required, which can be extremely expensive. Such processes have not been successfully applied to superalloys.

For some superalloy materials in the zone of non-weldability there is no known acceptable welding or repair process. Furthermore, as new and higher alloy content superalloys continue to be developed, the challenge to develop commercially feasible joining processes for superalloy materials continues to grow.

### BRIEF DESCRIPTION OF DRAWINGS

The invention is explained in the following description in view of the drawings that show:

FIG. 1 is a top sectional view of an airfoil of a turbine or vane of a turbine machine, including identified distressed regions on the airfoil substrate.

FIG. 2 is a schematic sectional view of a substrate configured for repair of a distressed region of the substrate using a meltable filler material.

FIG. 3 is a schematic sectional view of the substrate of FIG. 2 including a laser energy beam directed at the repair opening to melt the powdered filler material.

FIG. 4 is a schematic sectional view of a substrate configured for repair including a layer of flux material over the powdered filler material at the repair opening and showing a slag layer formed over a repair deposit layer.

FIG. 5 is a schematic illustration of a substrate configured for repair including a powdered filler material with a mixture of a powdered metal alloy and a powdered flux material.

FIG. 6A is a schematic section view of an airfoil with an insert supporting a powdered filler material in a repair opening.

FIG. 6B is a sectional view of the airfoil with insert and filler material taken along lines 6B-6B of FIG. 6A.

FIGS. 7A-7C is a schematic top view of a substrate distressed region configured for repair and a schematic representation of a laser energy beam dimension changing according to a geometric shape of the repair opening.

FIGS. 8A-8C is a schematic top view of a substrate distressed region configured for repair including a mask on the substrate and surrounding the repair opening.

FIG. 9 illustrates an energy beam overlap pattern.

FIG. 10 is a flowchart including steps in a method of repairing a metal substrate.

FIG. 11 is a prior art chart illustrating the relative weldability of various superalloys.

### DETAILED DESCRIPTION OF THE INVENTION

The present inventors have developed a process or method of repairing a substrate of a component using a powdered filler material that can be heated, melted and solidified. This method takes advantage of a feature of the component including internal cavities. More specifically, a distressed region on the substrate is identified and removed to form a repair opening adjacent to an internal cavity of the component. A filler material is then supported in the repair opening. In an embodiment, the internal cavity is filled with a meltable filler material that preferably includes a powdered metal alloy that generally matches a metal alloy composition of the substrate, wherein a bed of the filler material within the cavity supports filler material at or in the repair opening. Alternatively, an insert may be placed within the cavity to support the filler material at or in the repair opening. In an embodiment, an energy beam traverses the repair opening including the powdered filler material, melting the filler material to a depth corresponding to the thickness of the substrate. Because the filler material displaces any air in the cavity and because the filler material may include powdered shielding flux as well as powdered metal, embodiments of the invention obviate backside shielding and only external shielding of the filler material is required. By way of example, layer of powdered flux may be disposed over the filler material at the repair opening or mixed with the powdered metal alloy to create a slag layer during heating to protect the metal repair deposit layer from atmosphere during repair. Alternatively, the repair may be conducted in a chamber and an inert gas may be introduced external to the component or a vacuum is generated.

With respect to FIG. 1, a sectional view of an airfoil 10 for a turbine component such as a turbine blade or vane for a turbine machine is shown. A plurality of cooling holes 16 are formed through an external substrate 18 and are in fluid flow communication with internal cavities 20 such as cooling channels. The holes 16 and cavities 20 provide for fluid flow passage of air to cool the component during operation. Similarly, as known to those skilled in the art, the airfoil 10 may be formed on a platform (not shown), which may also have openings and cooling channels in fluid flow communication with the cavities 20 of the airfoil 10. While embodiments of the invention may be described in relation to a turbine blade, the invention is not so limited and may encompass other turbine components of a turbine machine. To that end, the invention is not limited to turbine machine components, but may be implemented for the repair of any component that requires the repair of a distressed region on an external substrate wherein the distressed region is adjacent to an internal cavity.

As further shown in FIG. 1, a number of distressed regions 26 are identified on the external substrate 18 for repair. These distressed regions may be the result of component wear, hot corrosion, foreign object damage and/or thermo-mechanical fatigue. As shown, the distressed regions 26 are adjacent to respective internal cavities 20 such as cooling channels. In order to repair these distressed regions, the turbine component is removed from the turbine machine for repair.

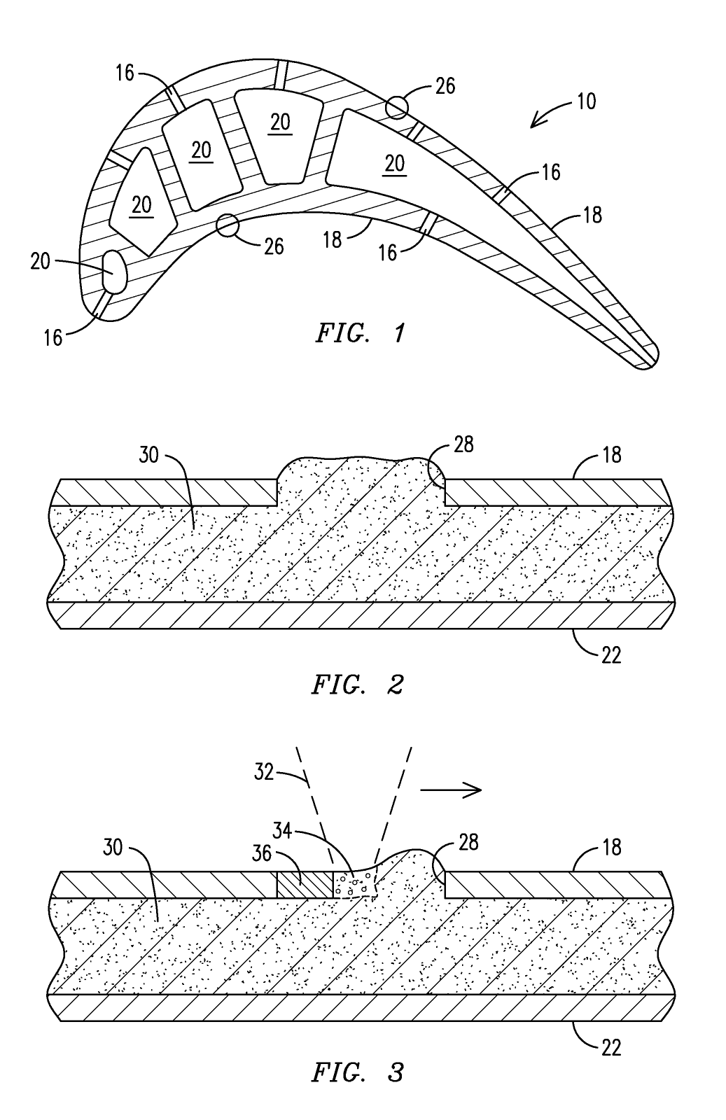

With respect to FIGS. 2 and 3, an external substrate 18 has been machined to form a repair opening 28. More specifically, portions of the substrate 18 surrounding the distressed region 26 are removed to form the repair opening 28 through the substrate 18. Repair processes according to embodiments of the invention may include removing portions of external outer coatings, such as thermal barrier coatings, machining or grinding the external substrate 18 to form the repair opening 28 and cleaning the substrate 18 surface for repair.

As further shown in FIG. 2, the channel or cavity 20 is filled with a filler material 30, such as a granulated metal powder that has a metal composition similar to a metal composition of the external substrate 18. Alternately such filler material may be granulated metal powder mixed with granulated flux, or composite metal/flux particles or granulated flux filling the cavity with granulated metal powder (or powder and flux) filling the opening. At least with respect to some turbine components, the substrate 18 may be composed of a nickel-based superalloy having constituent elements such as Cr, Co, Mo, W, Al, Ti, Ta, C, B, Zr and Hf. Accordingly, the filler material would contain a similar Ni-based superalloy composition in granulated powder form; however, the invention is not limited to a particular metal alloy or superalloy composition.

In the schematic illustrations of FIGS. 2 and 3, an opposing substrate 22 is shown and may include an internal substrate or opposing external substrate, which may or may not be integrally formed with substrate 18 and generally defines the cooling channel or cavity 20. The cavity 20 is filled such that the repair opening 28 is also filled with the filler material 30. That is filler material within the cavity 20 forms a bed of filler material supporting filler material in the repair opening 28. As one skilled in the art may appreciate, in addition to the repair opening 28 being formed through the substrate 18, to the extent that any other openings such as holes 16 are associated with an internal cavity 20, such openings may be plugged when the cavity 20 is filled with the filler material 30.

As further shown in FIG. 3, a laser beam 32 is traversed across the repair opening 28, and the filler material 30 in the repair opening 28, to melt the powder as illustrated by the molten region 34 which solidifies to form the repair deposit 36 across the repair opening 28. As the molten metal solidifies, the formed repair deposit 36 fuses with edges of the substrate 18 along the repair opening 28. After formation of the repair deposit 36 is complete any un-melted or un-consumed filler material 30 remaining in the cavity 20 is removed through one or more openings. In addition, post laser treatment steps are conducted such as machining or sanding at the clad-filled repair opening to smooth the surface of the component 10.

The repair process shown in FIGS. 2 and 3 may be performed in a repair chamber with optically transmissive panels or walls through which the laser beam 32 is transmitted for melting the filler material 30. A vacuum may be created in the chamber to protect the repair deposit 36 from the atmosphere and prevent oxidation of the metal powder 30 or repair deposit 36. Alternatively, an inert gas may be introduced into the chamber external of the component or into the component or cavity 20 to create a fluidized bed of filler material 30 to protect the metal powder and repair deposit 36 from the atmosphere. Still alternately, flux used in conjunction with the metal powder may provide required shield protection.

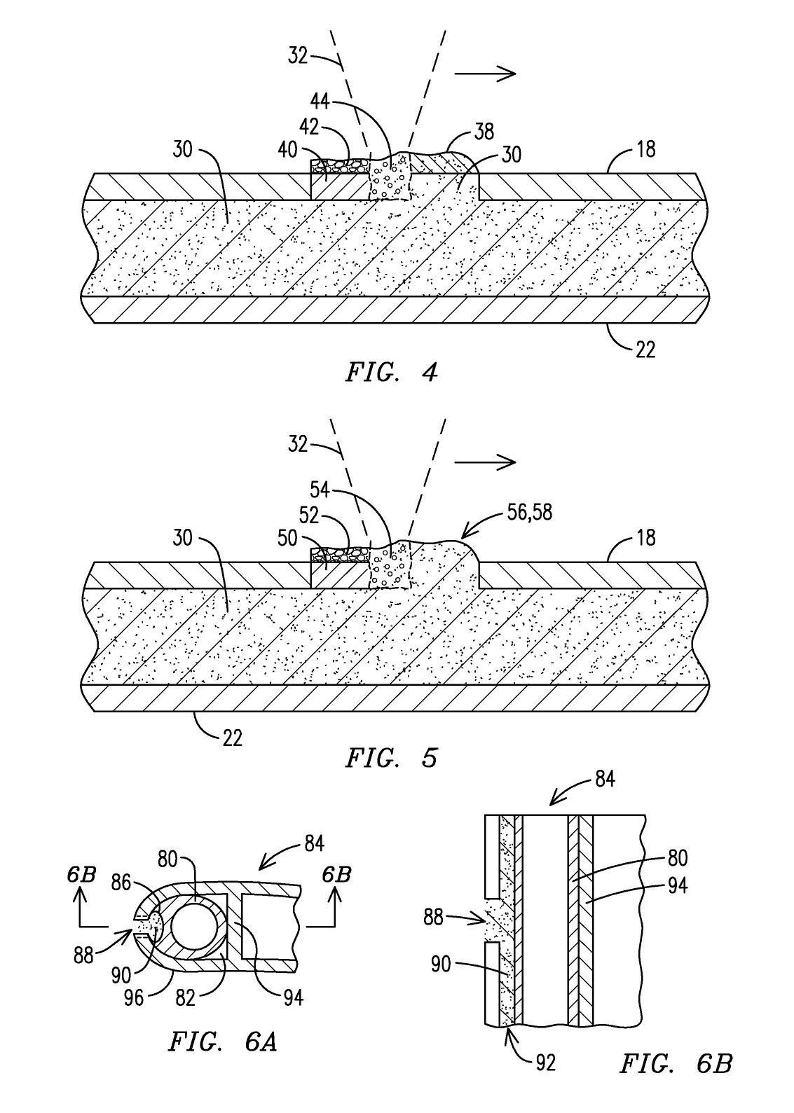

The energy beam 32 in the embodiment of FIGS. 2 and 3, and with respect to the below described embodiments of FIGS. 4 and 5, may be a diode laser beam having a generally rectangular cross-sectional shape, although other known types of energy beams may be used, such as electron beam, plasma beam, one or more circular laser beams, a scanned laser beam (scanned one, two or three dimensionally), an integrated laser beam, etc. The rectangular shape may be particularly advantageous for embodiments having a relatively large area to be clad; however, the beam may be adaptable to cover relatively small areas such as the above-described repair opening 28 formed at the distressed region 26. The broad area beam produced by a diode laser helps to reduce weld heat input, heat affected zone, dilution from the substrate and residual stresses, all of which reduce the tendency for the cracking effects normally associated with superalloy repair.

Optical conditions and hardware optics used to generate a broad area laser exposure may include, but are not limited to: defocusing of the laser beam; use of diode lasers that generate rectangular energy sources at focus; use of integrating optics such as segmented mirrors to generate rectangular energy sources at focus; scanning (rastering) of the laser beam in one or more dimensions; and the use of focusing optics of variable beam diameter (e.g., 0.5 mm at focus for fine detailed work varied to 2.0 mm at focus for less detailed work). The motion of the optics and/or substrate may be programmed as in a selective laser melting or sintering process to build a custom shape layer deposit. To that end, the laser beam source is controllable so that laser parameters such as the laser power, dimensions of the scanning area (repair opening) and traversal speed of the laser are controlled so that the thickness of the repair deposit 36 corresponds to the thickness of the substrate 18.

With respect to the embodiments shown in FIGS. 4 and 5 a powdered flux material is provided to protect the filler material 30 and repair deposit 40, 50. In the embodiment shown in FIG. 4, a layer of flux material 38 is provided over the filler material 30 at the repair opening 28. The laser beam 32 traverses the repair opening 28 to melt the granulated metal powder of the filler material 30, as represented by the molten region 44, to form the repair deposit 40 and slag 42. After the repair is completed and the component is allowed to cool, the slag 42 is removed using known mechanical techniques or cleaning processes.

FIG. 5 illustrates an embodiment where the filler material 30 includes a homogeneous mixture of a granulated powdered metal alloy 56 and a powdered flux material 58. Accordingly, when the laser beam 32 traverses the repair opening 28, the filler material 30, including the powdered metal alloy 56 and powdered flux material 58, is melted as represented by the molten region 54 and a repair deposit 50 is formed at the repair opening 28 covered by a layer of slag 52. Typical powdered prior art flux materials have particle sizes ranging from 0.5-2 mm, for example. However, the powdered alloy material 38 of FIG. 4 may have a particle size range (mesh size range) of from 0.02-0.04 mm or 0.02-0.08 mm or other sub-range therein. This difference in mesh size range may work well in the embodiment of FIG. 4 where the materials constitute separate layers; however, in the embodiment of FIG. 5, it may be advantageous for the powdered alloy material 56 and the powdered flux material 58 to have overlapping mesh size ranges, or to have the same mesh size range in order to facilitate mixing and feeding of the powders and to provide improved flux coverage during the melting process.

Still another alternate embodiment would involve using granulated flux material to fill the cavity and only placing metal powder or metal powder plus flux material at the repair opening. In such an embodiment, when a laser beam traverses the repair opening a layer of slag is formed over a repair deposit as described. In any of these described embodiments, once the repair is complete the slag is removed using known mechanical techniques or cleaning processes. In addition, any unconsumed filler material and/or flux material is removed from the internal cavity.

The flux material 38, 58 and resultant layer of slag 42, 52 provide a number of functions that are beneficial for preventing cracking of the repair deposit 40, 50. First, the slag 42, 52 functions to shield both the region of molten material and the solidified (but still hot) repair deposit material 40, 50 from the atmosphere in the region downstream of the laser beam 32. The slag floats to the surface to separate the molten or hot metal from the atmosphere, and the flux may be formulated to produce a shielding gas in some embodiments, thereby avoiding or minimizing the use of expensive inert gas. Second, the slag 42, 52 acts as a blanket that allows the solidified material to cool slowly and evenly, thereby reducing residual stresses that can contribute to post weld reheat or strain age cracking. Third, the flux material 38, 58 provides a cleansing effect for removing trace impurities such as sulfur and phosphorous that contribute to weld solidification cracking. Such cleansing includes deoxidation of the metal powder. Because the flux powder is in intimate contact with the metal powder, it is especially effective in accomplishing this function. Finally, the flux material 38, 58 may provide an energy absorption and trapping function to more effectively convert the laser beam 32 into heat energy, thus facilitating a precise control of heat input, such as within 1-2%, and a resultant tight control of material temperature during the process. Additionally, the flux may be formulated to compensate for loss of volatized elements during processing or to actively contribute elements to the deposit that are not otherwise provided by the metal powder itself.

Together, these process steps produce crack-free deposits of superalloy repair deposits for superalloy substrates at room temperature for materials that heretofore were believed only to be joinable with a hot box process or through the use of a chill plate. Advantages of this process over known laser melting or sintering processes include: high deposition rates and thick deposit in each processing layer; improved shielding that extends over the hot deposited metal without the need for inert gas; flux will enhance cleansing of the deposit of constituents that otherwise lead to solidification cracking; flux will enhance laser beam absorption and minimize reflection back to processing equipment; slag formation will shape and support the deposit, preserve heat and slow the cooling rate, thereby reducing residual stresses that otherwise contribute to strain age (reheat) cracking during post weld heat treatments; flux may compensate for elemental losses or add alloying elements; and powder and flux preplacement or feeding can efficiently be conducted selectively because the thickness of the deposit greatly reduces the time involved in total part building.

Flux materials which could be used include commercially available fluxes such as those sold under the names Lincolnweld P2007, Bohler Soudokay NiCrW-412, ESAB OK 10.16 or 10.90, Special Metals NT100, Oerlikon OP76, Sandvik 50SW or SAS1 or specialized fluxes that are specifically formulated for laser (versus arc) processing (i.e., without the need for arc stabilizers). The flux particles may be ground to a desired smaller mesh size range before use. Flux materials known in the art may typically include alumina, carbonates, fluorides and silicates. Embodiments of the processes disclosed herein may advantageously include metallic constituents of the desired repair deposit material, for example, chrome oxides, nickel oxides or titanium oxides. Any of the currently available iron, nickel or cobalt based superalloys that are routinely used for high temperature applications such as gas turbine engines may be joined, repaired or coated with the inventive process, including those alloys mentioned above.

In an embodiment shown in FIGS. 6A and 6B, an insert 80 is shown disposed within an internal cavity 82 of an airfoil 84 and supporting the filler material 90 in the repair opening 88. With respect to the repair of distressed regions on an external surface of the airfoil 84, a tip (not shown) may be removed or a portion of the airfoil 84 is removed to access the cavity 82. In some instances, the tip, or a portion thereof, of the airfoil 84 may be removed for repair. Once the insert 80 is securely in place within the cavity 82, any of the above-described filler materials 90 including a metal alloy, flux material or combinations thereof is placed within the cavity 82. This embodiment is desirable because less filler material, which may include expensive powdered metal alloy, is required to fill the cavity 82 to repair the distressed region of the airfoil 84.

As shown the insert 80 is sized to snugly fit against an external wall 96 and an internal wall 94 of the airfoil 84. In addition, the insert 80 may be elongated, wherein a bottom of the insert 80 abuts an internal surface of the component such as a surface of a platform (not shown) to further stabilize the insert 80 in the internal cavity 82. The insert 80 should be composed of a material resistant to the heat applied to the filler material 90 across the repair opening 88 so that material of the insert 80 does not react with or otherwise compromise the composition of the filler material 90. For example, the insert 80 may be composed of steel or a steel alloy or a ceramic material. Alternatively, a steel wool material can be used as an insert. In addition, as shown in FIGS. 6A and 6B, the insert 80 may have an indented or concave surface 86 facing the opening 88 forming a fill area 92 between the insert 80 and the repair opening 88. This particular configuration displaces the surface of the insert 80 from the repair opening 88 reducing the exposure of the insert 80 to heat applied to the filler material 90 across the opening 88. Inasmuch as the repair deposit formed, after the filler material across the opening 88 is melted and cooled, will protrude slightly in the internal cavity 82, the repair deposit will not have sharp angles relative to the internal surface of the airfoil 84, which can create stress points at the repair deposit. Heat resistant materials such as ceramics may not require the concave configuration and may include a surface that is flush against an internal surface of the airfoil 84, requiring even less filler material 30.

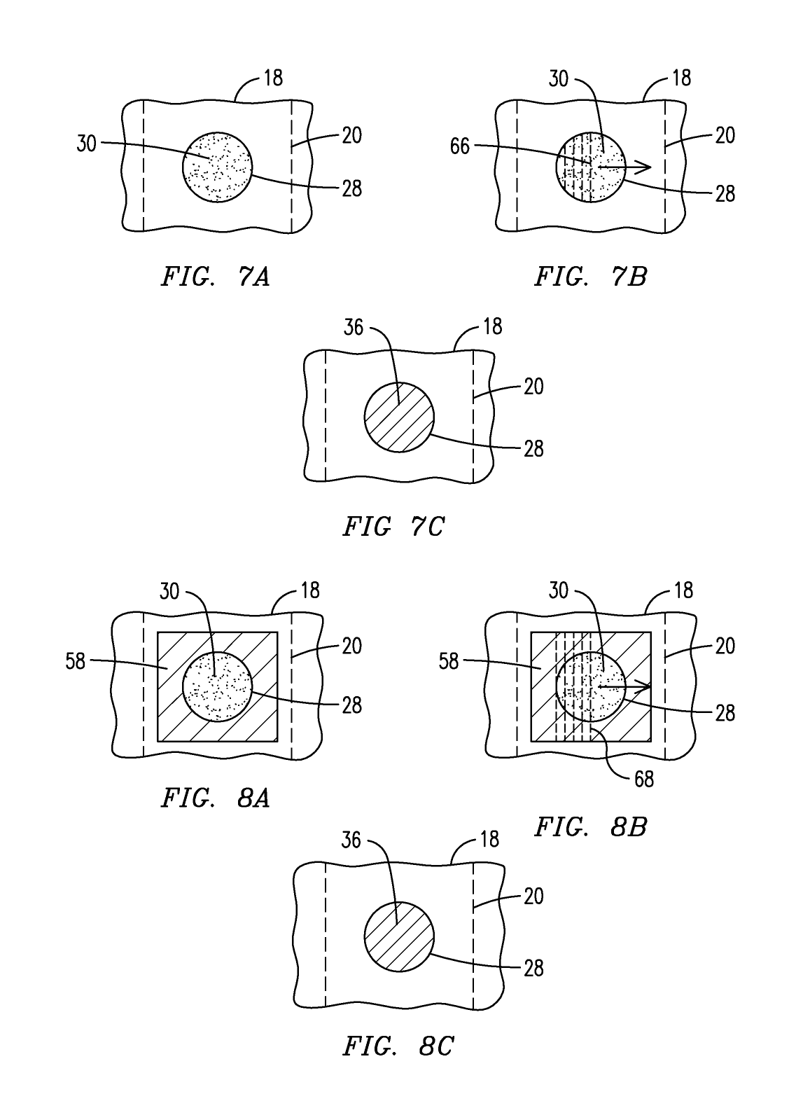

As mentioned above the laser energy beam may have a generally rectangular energy density. With respect to FIGS. 7A, 7B and 7C, a repair of a substrate 18 is schematically illustrated with a laser beam 66 being represented by dashed lines in FIG. 7B. With respect to FIG. 7A a repair opening 28 and an associated cavity 20 is shown filled with a filler material 30 such as a granulated powdered metal alloy having generally a similar metal alloy composition to that of the substrate 18. While the opening 28 has a circular shape, the shape of the opening may be any geometric shape necessary to complete the repair. As shown in FIG. 7B, the laser beam 66 is controlled so that its width dimension corresponds to a changing dimension of the opening as the laser beam 32 traverses the opening to form the repair deposit 36 of FIG. 7C. By thus controlling the dimensions of the laser beam 66, the heating step is limited to heating of the filler material 30 and avoids damaging the substrate 18.

In an alternate embodiment shown in FIGS. 8A-8C, the width dimension of the laser beam 68 is not adjusted as it traverses the repair opening 28. Accordingly, a mask 58 is provided to cover the substrate 18 around the opening 28 to absorb or reflect the laser beam 68 as it traverses the opening 28 and form the repair deposit 36. A reflective mask may be composed of reflective type material such as copper; and, an absorptive mask may be composed of an absorptive material such as graphite. The mask is provided to protect the undamaged areas of the substrate 18 from the laser beam 68, which may melt the substrate as it traverses the opening 28.

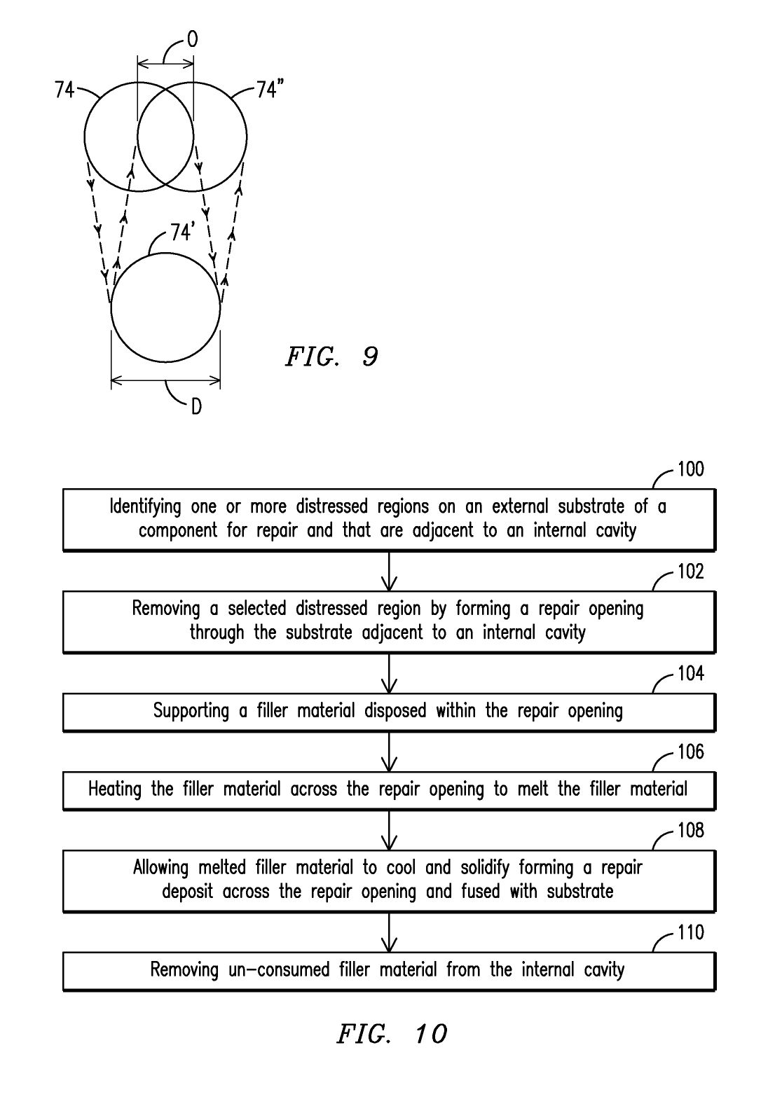

Alternatively, it is possible to raster a circular laser beam back and forth as it is moved forward along a substrate to effect an area energy distribution. FIG. 9 illustrates a rastering pattern for one embodiment where a generally circular beam having a diameter D is moved from a first position 74 to a second position 74′ and then to a third position 74″ and so on. An amount of overlap O of the beam diameter pattern at its locations of a change of direction is preferably between 25-90% of D in order to provide optimal heating and melting of the materials. Alternatively, two energy beams may be rastered concurrently to achieve a desired energy distribution across a surface area, with the overlap between the beam patterns being in the range of 25-90% of the diameters of the respective beams.

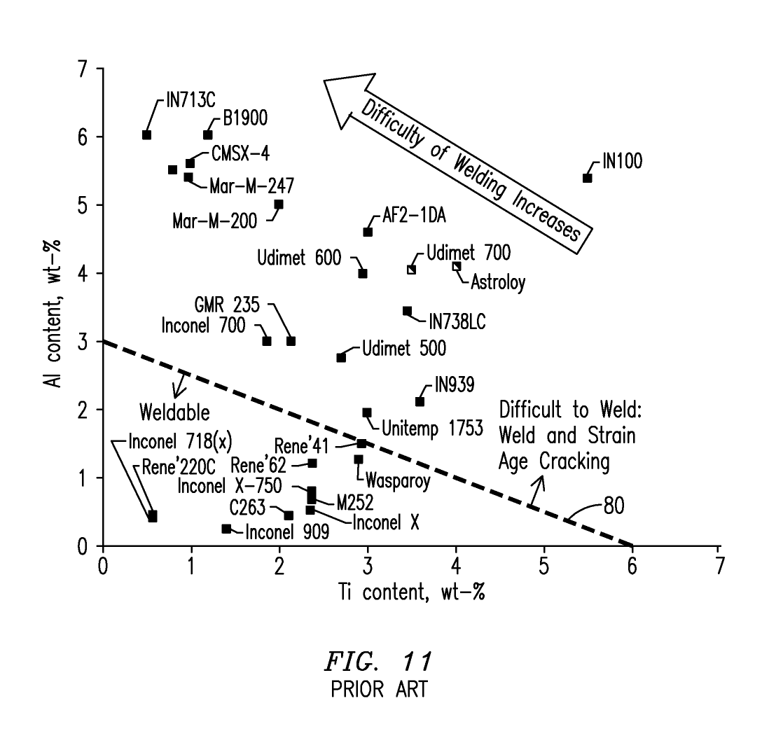

With respect to the flow chart of FIG. 10, steps in a method of repairing a substrate are described. At step 100, one or more distressed regions on a component substrate are identified for repair, and those distressed regions are preferably adjacent to a cavity. Then at step 102, portions of the substrate at the distressed region are removed to form a repair opening through the substrate and the opening is adjacent to the internal cavity. Additional processing such as removal of external coatings and cleaning surfaces of the substrate may also be performed.

After the substrate is prepared as described above, at step 104 the internal cavity and repair opening are filled with a filler material. As described above, the filler material may be a powdered metal alloy or superalloy having a composition corresponding to the composing of a metal alloy or superalloy substrate. Then at step 106, the filler material is heated across the repair opening to melt the filler material. This heating step may be performed using an energy beam, such as a laser beam, that traverses the repair opening to melt the filler material. The energy beam may be controlled so that a sufficient amount or depth of the filler material is melted so that the repair deposit layer formed on cooling has a thickness corresponding to a thickness of the substrate.

In addition, the heating step may be performed in a sealed chamber in a vacuum or with introduction of an inert gas. To that end, a layer of powdered flux material may be provided over the filler material in the repair opening before the step of heating. Alternatively, the filler material may include a mixture of powdered metal alloy or superalloy and a powdered flux material. In other embodiments, the filler material may include a powder composed of composite metal/flux granulated particles or flux material may be disposed within the cavity with supporting an overburden of a metal in the opening. These described flux applications will create a layer of slag that protects the filler material and repair deposit during the heating step.

At step 108, the molten or melted filler material is allowed to cool to form the repair deposit across the repair opening. Inasmuch as the repair deposit will have a metal alloy composition similar to that of the substrate, and a sufficient heat is applied to the filler material, the repair deposit will fuse to the substrate along edges of the repair opening. Then at step 110, any un-consumed filler material and/or flux material will be removed from the internal cavity. Additional post heating and cooling steps may be performed such as mechanically machining, sanding, etc., to refine the repair deposit and smooth the surface of the substrate. To the extent that slag is present over the repair deposit, known mechanical and chemical removal/cleaning processes may be used to remove the slag. Moreover, external coatings may be deposited on the repair deposit as necessary for repair of the substrate.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of repairing a distressed region of a substrate of a component with a filler material supported within the component, comprising:
providing a component for repair wherein the component has a distressed region on an external substrate adjacent to an internal cavity of the component;
forming a repair opening at the distressed region and through the external substrate;
supporting a filler material in the repair opening;
applying heat across the filler material in the repair opening to melt the filler material in the repair opening;
allowing the melted filler material in the repair opening to cool and solidify to form a repair deposit across the repair opening; and,
removing any unconsumed filler material from the internal cavity of the component through an opening in the component in fluid communication with the internal cavity.

2. The method of claim 1, further comprising controlling the heat across to repair opening such that a sufficient amount of filler material is melted and when cooled the repair deposit has a thickness corresponding to a thickness of the substrate.

3. The method of claim 1, wherein the substrate is composed of a metal alloy and the filler material is composed of a powdered metal alloy having a composition corresponding to the composition of the substrate metal alloy.

4. The method of claim 3, wherein the filler material comprises a mixture of the powdered metal alloy and a powdered flux material.

5. The method of claim 4, further comprising selecting a mesh size range of the powdered metal alloy and the powdered flux material to overlap.

6. The method of claim 3, further comprising forming a slag over the repair deposit when the filler material is melted.

7. The method of claim 1, further comprising providing a layer of powdered flux material over the filler material in the repair opening.

8. The method of claim 7, further comprising forming a slag over the repair deposit when the filler material is melted.

9. The method claim 1, wherein the step of supporting the filler material in the repair opening includes at least partially filling the internal cavity with the filler material.

10. The method of claim 1, wherein the step of supporting the filler material in the repair opening includes at least partially filling the cavity with a powdered flux material and the filler material in the repair opening is composed of a metal powder or a combination of metal powder and a powdered flux material.

11. The method of claim 1, wherein the step of supporting the filler material in the repair opening includes placing an insert in the internal cavity adjacent to the repair opening to support the filler material in the repair opening.

12. The method of claim 11, wherein the insert comprises steel wool.

13. The method of claim 11, wherein the insert has a generally concaved surface facing the repair opening.

14. The method of claim 11, wherein the insert comprises steel or a steel alloy.

15. The method of claim 11, wherein the insert comprises a ceramic material.

16. A method for repairing an external substrate of a component of a turbine machine, wherein the component includes one or more internal cavities relative to the external substrate, comprising:
removing a distressed region on the external substrate, wherein the distressed region is adjacent to an internal cavity of the component, to form a repair opening through the external substrate;
supporting a powdered filler material in the repair opening;
applying heat to the powdered filler material to melt the material in the repair opening;
allowing melted powdered repair material in the repair opening to cool and solidify to form a repair deposit across the repair opening; and
removing any unconsumed powdered filler material from the internal cavity of the component through an opening in the component in fluid communication with the internal cavity.

17. The method of claim 16, wherein the powdered filler material comprises a powdered metal alloy.

18. The method of claim 16, wherein the step of applying heat comprises applying an energy beam to the powdered filler material in the repair opening.

19. The method of claim 18, wherein the step of applying heat further comprises traversing a laser energy beam across the repair opening.

20. The method of claim 19, further comprising controlling a width dimension of the laser beam to correspond to peripheral dimensions of the repair opening.

21. The method of claim 19, further comprising providing a mask over the substrate and surrounding the repair opening.

22. The method of claim 16, wherein the powdered filler material comprises a mixture of a powdered metal alloy and a powdered flux material.

23. The method of claim 16, further comprising covering the powdered filler material in the opening with a layer of powdered flux material.

24. The method of claim 16, wherein the repair of the component is performed in a sealed chamber and the method further comprising supplying an inert gas into the chamber during the heating step.

25. A method for repairing an external superalloy substrate of a component having one or more internal cavities, comprising:
forming a repair opening at a distressed area on the external superalloy substrate, wherein the distressed opening is adjacent to an internal cavity of the component;
supporting a powdered metal alloy in the repair opening wherein the powdered metal alloy has a composition matching that of the external superalloy substrate;
traversing the repair opening with an energy beam to form a superalloy deposit across the repair opening that is fused to the superalloy external substrate; and,
removing un-consumed powdered metal alloy from the cavity through an opening in the component.
